(19) United States
(12) Patent Application Publication
(10) Pub. No.: US 2021/0164286 A1
(43) Pub. Date: Jun. 3, 2021

(54) ADJUSTABLE DOOR FRAME MOUNTING SYSTEM AND METHOD

(71) Applicant: National Guard Products, Inc., Memphis, TN (US)

(72) Inventors: Derald Gene Dancy, Collierville, TN (US); Jeffrey Wayne Brewer, Somerville, TN (US)

(73) Assignee: National Guard Products, Inc., Memphis, TN (US)

(21) Appl. No.: 17/109,470

(22) Filed: Dec. 2, 2020

Related U.S. Application Data
(60) Provisional application No. 62/942,985, filed on Dec. 3, 2019.

(51) Int. Cl. E06B 3/46; E05D 15/06

(52) U.S. Cl. CPC E06B 3/4654; E05Y 2900/14; E05D 15/0652

(57) ABSTRACT

A kit for installing a pocket door system in a doorway, comprising: a frame header and track assembly installed horizontally at an uppermost end of a rough opening in a wall; and a plurality of vertical support structures fixed to the frame header and track assembly and defining a pocket opening in the wall for receiving a sliding door. Each of the plurality of vertical support structures includes a first vertical member, one or more second vertical member, and a component configured to connect the one or more second vertical members to the first vertical member in order to achieve a selected door height.

### CROSS REFERENCE TO RELATED APPLICATION

This application claims priority to U.S. Provisional Patent Application No. 62/942,985 filed on Dec. 3, 2019, entitled “ADJUSTABLE DOOR FRAME MOUNTING SYSTEM AND METHOD,” the content of which is incorporated by reference herein in its entirety.

### FIELD OF TECHNOLOGY

The present disclosure generally relates to a door frame mounting system and method, and more particularly relates to a pocket door frame kit designed to accommodate doors in different heights.

### BACKGROUND

A pocket door is a type of door that opens by sliding along a track into a pocket enclosed within a wall. The door may likewise be closed by sliding it out of the wall pocket and across a doorway opening. When in an open position, the pocket door is hidden within the wall pocket resulting in a cleaner visual aesthetic and a more efficient use of available space than conventional swing doors.

Commercially available pocket door systems are offered either as kits with all the components included for installation or as pre-assembled units for doors of standard heights (e.g., 6 feet, 8 inches or 7 feet in length). Non-standard pocket doors use special tracks, hardware, and components of various dimensions which are required to be custom-built.

Accordingly, there is a need for providing an adjustable pocket door frame mounting system and method to accommodate doors of different heights. In particular, it is desirable to facilitate installations of pocket doors of different heights via commercially available pocket door frame kits in order to reduce the costs, delays, and inconveniences that are associated with custom-building relevant components.

### SUMMARY

Among other features, the present disclosure provides a system, comprising: a plurality of first vertical support structures of a door frame construction, each first vertical support structure having a first length; a plurality of second vertical support structures, each second vertical support structure having a second length; and means for connecting at least one first vertical support structure and at least one second vertical support structure to achieve a desired door height.

In one aspect, the first length corresponds to an industry standard length of a door frame member. One or more second vertical support structures are configured to incrementally increase at least one first vertical support structure to the desired door height, wherein the second length is shorter than the first length and ranges from 6″ to 36″. Each of the first and second vertical support structures comprises a channel member configured to receive a wooden core. In one embodiment, the channel member has a substantially C-shaped or U-shaped cross-section and is made of heavy-gauge galvanized cold rolled steel or stainless steel.

In another aspect, the first and second vertical support structures are connected with each other at a selected distal end via the means. The selected distal end of each of the first and second vertical support structures comprises a first plurality of mounting holes for receiving a plurality of fasteners and attaching with the means. The means for connecting the first and second vertical support structures comprises a second plurality of mounting holes configured to align with the first plurality of mounting holes for receiving the plurality of fasteners.

The present disclosure also provides a kit for installing a pocket door system in a doorway. The kit comprises a frame header and track assembly installed horizontally at an uppermost end of a rough opening in a wall; and a plurality of vertical support structures fixed to the frame header and track assembly on one end to define a pocket opening in the wall for receiving a sliding door. Each vertical support structure includes at least one first vertical member having a first length, at least one second vertical member having a second length, and a component configured to connect the at least one first and second vertical members to a desired door height.

In one aspect, the first length corresponds to an industry standard length of a door frame member. The at least one second vertical member incrementally increases the at least one first vertical member to the desired door height, wherein the second length is shorter than the first length and ranges from 6″ to 36″. Each of the at least one first and second vertical members comprises a channel member configured to receive a wooden core. In one embodiment, the channel member has a substantially C-shaped or U-shaped cross-section and is made of heavy-gauge galvanized cold rolled steel or stainless steel.

In another aspect, the at least one first and second vertical members are connected with each other at a selected distal end via the component. The selected distal end of each of the at least one first and second vertical members comprises a first plurality of mounting holes for receiving a plurality of fasteners and attaching with the component. In one embodiment, the component has a substantially C-shaped or U-shaped cross-section and is made of heavy-gauge galvanized cold rolled steel or stainless steel. The component for connecting the at least one first and second vertical members comprises a second plurality of mounting holes configured to align with the first plurality of mounting holes for receiving the plurality of fasteners.

The present disclosure also provides a method for installing a pocket door system in a doorway. The method comprises installing a frame header and track assembly horizontally at an uppermost end of a rough opening in a wall; and fixing a plurality of vertical support structures to the frame header and track assembly, the plurality of vertical support structures defining a pocket opening in the wall for receiving a sliding door. Each vertical support structure includes at least one first vertical member having a first length, at least one second vertical member having a second length, and a component configured to connect the at least one first and second vertical members to a desired door height.

In one aspect, the first length corresponds to an industry standard length of a door frame member. The method further comprises incrementally extending the at least one first vertical member to the desired door height using the at least one second vertical member, wherein the second length is shorter than the first length and ranges from 6″ to 36″. Each of the at least one first and second vertical member comprises a channel member configured to receive a wooden core. In one embodiment, the channel member has a substantially C-shaped or U-shaped cross-section and is made of heavy-gauge galvanized cold rolled steel or stainless steel.

The method further comprises connecting the at least one first and second vertical members with each other at a selected distal end via the component, providing a first plurality of mounting holes on the selected distal end of each of the at least one first and second vertical members, and receiving a plurality of fasteners and attaching with the component via the first plurality of mounting holes. In one embodiment, the component has a substantially C-shaped or U-shaped cross-section and is made of heavy-gauge galvanized cold rolled steel or stainless steel.

The method further comprises providing a second plurality of mounting holes on the component for connecting the first and second vertical members, aligning with the first and second plurality of mounting holes for receiving the plurality of fasteners, extending each vertical support structure to the desired door height using two or more second vertical members, and attaching the at least one second vertical member to a top edge or a bottom edge of the at least one first vertical member.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a pocket door frame mounting system, according to an exemplary aspect of the present disclosure;

FIG. 2 illustrates a first jamb member having a first length, according to an exemplary aspect of the present disclosure;

FIG. 3 illustrates a second jamb member having a second length, according to an exemplary aspect of the present disclosure;

FIGS. 4(a) and 4(b) illustrate various views of the first and second jamb members connected by a component to form an integral vertical support structure of the pocket door frame mounting system of FIG. 1, according to an exemplary aspect of the present disclosure; and

FIG. 5 illustrates a component for connecting the first and second jamb members, according to an exemplary aspect of the present disclosure.

### DETAILED DESCRIPTION

Various aspects of the present disclosure will be described with reference to the drawings, wherein like reference numerals are used to refer to like elements throughout. In the following description, for purposes of explanation, numerous specific details are set forth in order to promote a thorough understanding of one or more aspects of the invention. It may be evident in some or all instances, however, that any aspects described below can be practiced without adopting the specific design details described below.

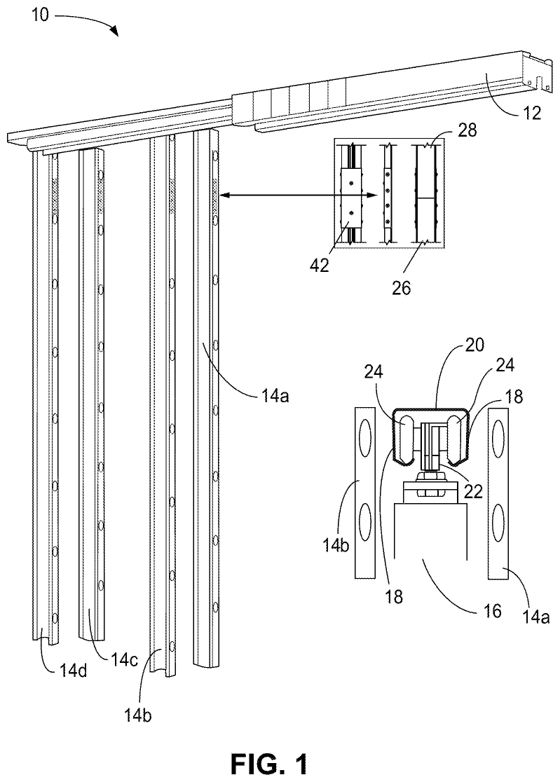

Referring to FIG. 1, a pocket door frame mounting system 10 is illustrated, according to aspects of the present disclosure. System 10 may be installed within a rough opening in a load-bearing or non-bearing wall, prior to the installation of drywalls or other suitable types of wall surface finish. System 10 may include a frame header and track assembly 12 installed horizontally at an uppermost end of the rough opening and a plurality of vertical support structures 14a, 14b, 14c, and 14d fastened to the assembly 12 to form a rigid pocket frame structure. System 10 may be configured to support and house a sliding door or panel member 16 for rectilinear movement across a door opening and into and out of a recessed or hidden pocket spacing between the vertical support structures 14a-14d positioned between two opposing walls of a structural wall or partition. The frame header and track assembly 12 may provide a pair of opposing track portions 18 extending downwardly from a central plate portion 20. Each track portion 18 may generally have a C-shaped cross section in configuration and is spaced from each other to receive trolley assemblies 22 which may be secured to an upper edge of the sliding door 16 via any suitable means. In one embodiment, the maximum weight load of the frame header and track assembly 12 of system 10 may be up to 250 lb. Trolley assemblies 22 may include two or more rollers 24 that are spaced apart from each other in order to move in each respective track portions 18, such that the sliding door 16, which is suspended from the trolley assemblies 22 and above the floor, may freely move in the door opening and into and out of the wall pocket between a fully open position and a fully closed position. The spacing between two opposing pair of vertical support structures 14a, 14b and 14c, 14d may be configured to accommodate the sliding door 16 of different thicknesses ranging from, e.g., 1⅜″ to 1¾″.

According to aspects of the present disclosure, the length of each vertical support structure 14a-14d may be configured to be adjustable or extendable to provide a desired pocket door height. In one embodiment, as shown in FIGS. 1, 2, 3, 4(a) and 4(b), each vertical support structure 14a-14d may comprise two or more jamb members 26, 28 that may be in different lengths and configured to join or connect with each other securely via a connector component 42.

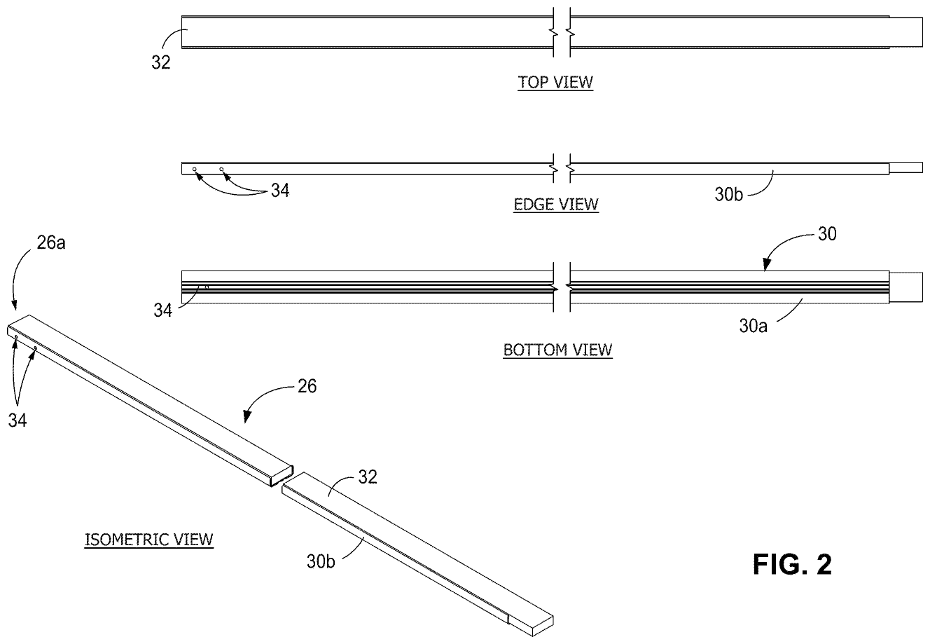

Referring to FIG. 2, a first jamb member 26 may have a first length (e.g., an industry standard wall stud length of 82-88″). Jamb member 26 may include a channel member 30 configured to receive a wooden core 32. The channel member 30 may be made of heavy-gauge galvanized cold rolled steel or stainless steel in order to resist rust due to rain or ambient humidity in the environment surrounding system 10 and maintain a rigid pocket structure of system 10. In one embodiment, channel member 30 may be generally C-shaped or U-shaped having a base panel 30a and two opposing and substantially parallel legs or side walls 30b for placing over and wrapping around the wooden core 32, which may have a rectangular cross section, on three continuously adjacent surfaces. The wooden core 32 may extend substantially the full width and length of a corresponding channel member 30 and provide one surface for receiving any suitable fastening means thereon. Connecting means such as multiple mounting holes 34 may be provided on, e.g., a selected distal end 26a of the channel member 30 and the wooden core 32, for receiving corresponding fasteners, such that jamb member 26 may securely connect with other components of system 10 to achieve a desired pocket door height, as will be described fully below. In one embodiment, a portion of the mounting holes 34 may be positioned along each side wall 30b and along a centerline of the base panel 30a of the channel member 30, respectively.

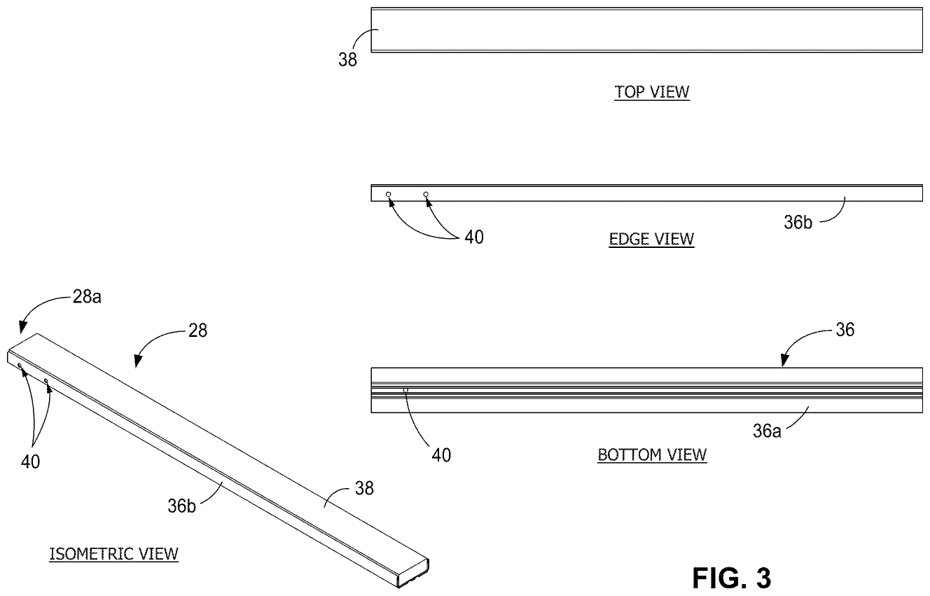

Referring to FIG. 3, according to aspects of the present disclosure, a second door jamb member 28 may have a second length (e.g., 6″-36″) or a length shorter than the first jamb member 26. One of the functions of jamb member 28 may include incrementally extending the length of the first jamb member 26 to a desired door height. Jamb members 26 and 28 may be structurally similar to each other (e.g., having substantially the same profile and construct), thereby providing the necessary mechanical strength and durability when joined together. Jamb member 28 may similarly include a channel member 36 having a substantially C-shaped or U-shaped cross-section with a base panel 36a and two opposing and substantially parallel legs or side walls 36b for placing over and wrapping around a wooden core 38, which may have a rectangular cross section, on three continuously adjacent surfaces. The channel member 36 may be made of heavy-gauge galvanized cold rolled steel or stainless steel in order to resist rust due to rain or ambient humidity in the environment surrounding system 10 and maintain a rigid pocket structure of system 10. The wooden core 38 may extend substantially the full width and length of a corresponding channel member 36 and provide one surface for receiving any suitable fastening means thereon. Connecting means such as a number of mounting holes 40 may be provided on, e.g., a selected distal end 28a of the channel member 36 and the wooden core 38, for receiving corresponding fasteners, such that jamb member 28 may securely connect with other components of system 10 to achieve a desired pocket door height, as will be described fully below. In one embodiment, a portion of the mounting holes 40 may be positioned along each side wall 36b and along a centerline of the base panel 36a of the channel member 36, respectively.

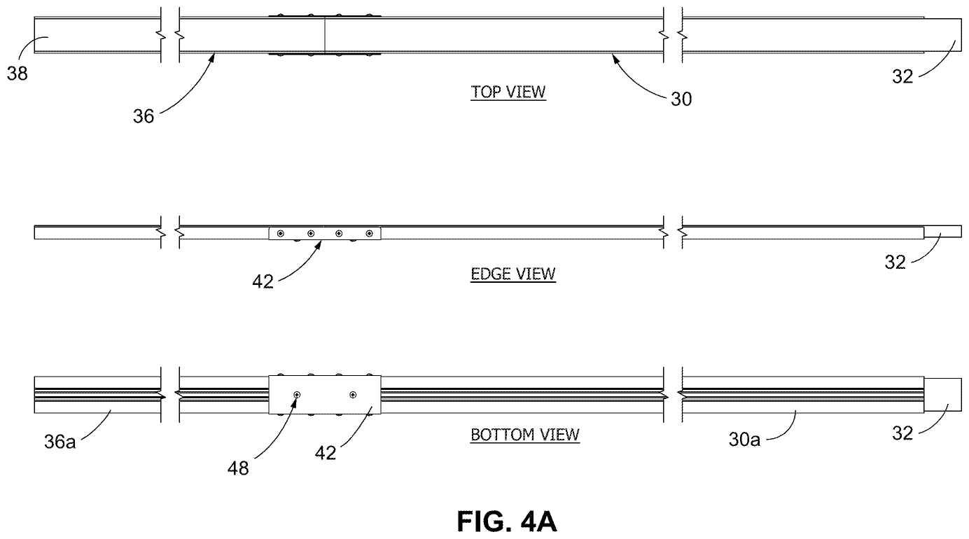

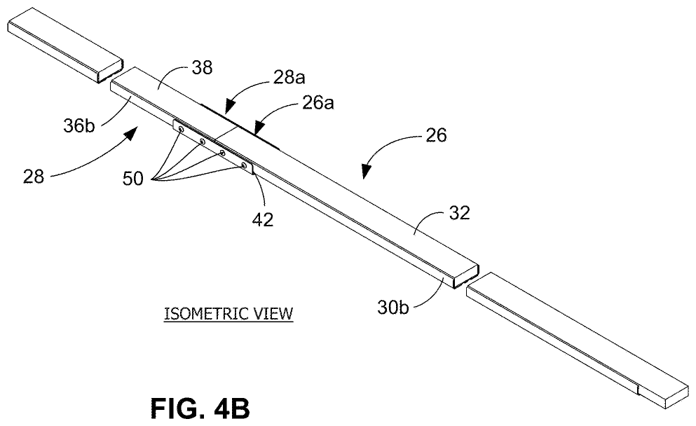

FIGS. 1, 4(a) and 4(b) show two jamb members 26 and 28 securely and removably joined together via a connector component 42 to form one or more vertical support structures (e.g., 14a-14d shown in FIG. 1) of system 10. According to aspects of the present disclosure, the length of each jamb member 26, 28 may be independently adjusted (e.g., cut or saw to a desired length on one end), and a combined length of both jamb members when joined together may accommodate a pocket door height ranging from, e.g., 6 feet, 8 inches to 9 feet. For example, where the height of a pocket door exceeds a standard-length jamb member (e.g., the length of jamb member 26) provided in a commercially available pocket door frame kit, one or more jamb extension members 28 may be adjusted in length accordingly and securely fastened to the standard-length jamb member via the connector component 42 in an end-to-end abutment in order to achieve a desired door height. As described above in connection with FIGS. 2 and 3, distal ends 26a and 28a of jamb members 26 and 28 may be configured to include suitable connecting means (e.g., a number of mounting holes 34 and 40) for attaching with the connector component 42. It should be appreciated that any other suitable connecting means such as adhesive, frictional tabs, insert-molding techniques may be use for attaching jamb members 26, 28 and the connector component 42 together.

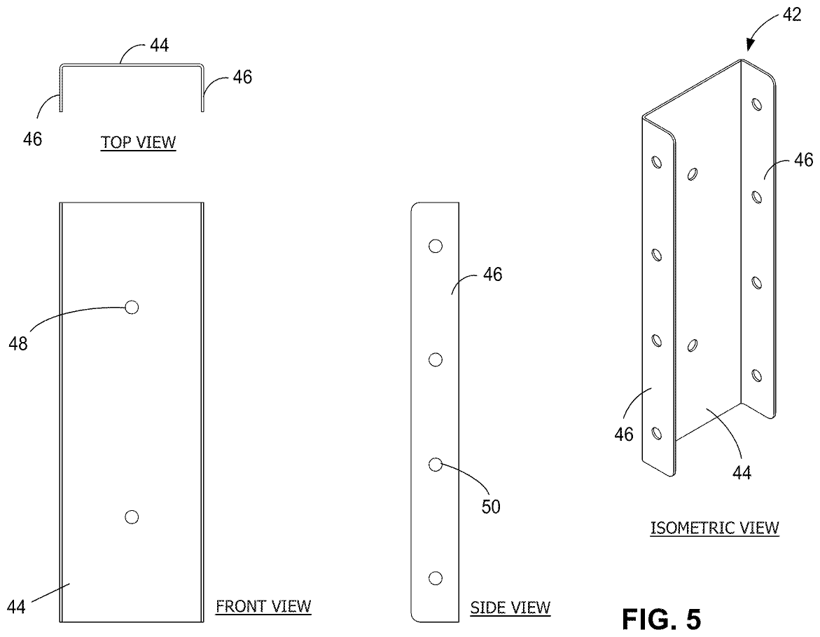

As shown in FIGS. 1, 4(a), 4(b), and 5, the connector component 42 may be generally U-shaped having a base panel 44 and two opposing and substantially parallel legs or side walls 46, similar to the cross section of the channel members 30 and 36. The connector component 42 may be made of heavy-gauge galvanized cold rolled steel or stainless steel in order to resist rust due to rain or ambient humidity in the environment surrounding system 10. The width of the base panel 44 may be slightly greater than that the channel members 30 and 36, such that when engaged together, the connector component 42 may tightly wrap around the jamb members 26 and 28 to ensure sufficient mechanical strength and stability at the joint. A number of mounting holes 48 and 50 may be provided on the base panel 44 and each leg 46, respectively. In one embodiment, in order to attach and hold two proximately abutting jamb members 26 and 28 in place, the connector component 42 may be positioned to have a tight engagement with the outer surface of channel members 30 and 36. Further, mounting holes 48 and 50 along the centerline of base panel 44 and on each leg 46 may be correspondingly aligned with the mounting holes 34 and 40 of each jamb member 26 and 28 to allow the installation of a number of fasteners therethrough in order to prevent any lateral movement between jamb members 26 and 28 at the joint.

Optionally, an additional connector component 42 may be used to wrap around the jamb members 26, 28 at a selected position and have a tight engagement with the outer surface of wooden cores 32 and 38 and the side walls 30b and 36b of the channel members 30 and 36, thereby providing increased mechanical strength and durability.

As shown in FIG. 1, jamb member 28 may be attached to the top of jamb member 26, thereby providing an extension of length from the top edge of jamb member 26 to the header and track assembly 12. In a different embodiment, jamb member 28 may be attached to the bottom of jamb member 26, thereby providing an extension of length from the bottom edge of jamb member 26 to the floor. Further, it should be appreciated that any number of jamb members 26 and 28 may be connected together via one or more connector components 42 to achieve a desired door height.

In yet another embodiment, the door frame mounting system 10 of the present disclosure may be used in curved walled enclosures such as airplanes, submarines, space shuttles, railroad cars, buses and the like.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A kit for installing a pocket door system in a doorway, comprising:
a frame header and track assembly installed horizontally at an uppermost end of a rough opening in a wall; and
a plurality of vertical support structures fixed to the frame header and track assembly and defining a pocket opening in the wall for receiving a sliding door,
wherein each of the plurality of vertical support structures includes:
a first vertical member having a first length,
one or more second vertical members, each second vertical member having a second length, wherein the second length is shorter than the first length and ranges from 6″ to 36″, and
a component configured to connect the one or more second vertical members to the first vertical member in order to achieve a selected door height.

2. The kit of claim 1, wherein the first length corresponds to an industry standard length of a door frame member.

3. The kit of claim 1, wherein each of the first and second vertical members comprises a channel member configured to receive a wooden core.

4. The kit of claim 3, wherein the channel member has a substantially C-shaped or U-shaped cross-section and is made of heavy-gauge galvanized cold rolled steel or stainless steel.

5. The kit of claim 1, wherein the first vertical member and the one or more second vertical members are connected with each other at a selected distal end via the component.

6. The kit of claim 5, wherein the selected distal end of each of the first and second vertical members comprises a first plurality of mounting holes for receiving a plurality of fasteners and attaching with the component.

7. The kit of claim 6, wherein the component has a substantially C-shaped or U-shaped cross-section and is made of heavy-gauge galvanized cold rolled steel or stainless steel.

8. The kit of claim 7, wherein the component for connecting the first and second vertical members comprises a second plurality of mounting holes configured to align with the first plurality of mounting holes for receiving the plurality of fasteners.

9. The kit of claim 1, wherein the one or more second vertical members are attached to a top edge of the first vertical member.

10. The kit of claim 1, wherein the one or more second vertical members are attached to a bottom edge of the first vertical member.

11. A method for installing a pocket door system in a doorway, comprising:
installing a frame header and track assembly horizontally at an uppermost end of a rough opening in a wall; and
fixing a plurality of vertical support structures to the frame header and track assembly, the plurality of vertical support structures defining a pocket opening in the wall for receiving a sliding door,
wherein each of the plurality of vertical support structure includes:
a first vertical member having a first length,
one or more second vertical members, each second vertical member having a second length, wherein the second length is shorter than the first length and ranges from 6″ to 36″, and
a component configured to connect the one or more second vertical members to the first vertical member in order to achieve a selected door height.

12. The method of claim 11, wherein the first length corresponds to an industry standard length of a door frame member.

13. The method of claim 11, wherein each of the first and second vertical members comprises a channel member configured to receive a wooden core.

14. The method of claim 13, wherein the channel member has a substantially C-shaped or U-shaped cross-section and is made of heavy-gauge galvanized cold rolled steel or stainless steel.

15. The method of claim 11, further comprising connecting the first vertical member and the one or more second vertical members with each other at a selected distal end via the component.

16. The method of claim 15, further comprising:
providing a first plurality of mounting holes on the selected distal end of each of the first and second vertical members; and
receiving a plurality of fasteners and attaching with the component via the first plurality of mounting holes by each of the first and second vertical members.

17. The method of claim 11, wherein the component has a substantially C-shaped or U-shaped cross-section and is made of heavy-gauge galvanized cold rolled steel or stainless steel.

18. The method of claim 17, further comprising:
providing a second plurality of mounting holes on the component for connecting the first and second vertical members; and
aligning with the first and second plurality of mounting holes for receiving the plurality of fasteners by each of the first and second vertical members.

19. The method of claim 11, further comprising attaching the one or more second vertical members to a top edge of the first vertical member.

20. The method of claim 11, further comprising attaching the one or more second vertical members to a bottom edge of the first vertical member.
